(19) United States
(12) Patent Application Publication
(10) Pub. No.: US 2024/0151957 A1
(43) Pub. Date: May 9, 2024

(54) MICROSCOPY SYSTEM AND METHOD FOR OPERATING A MICROSCOPY SYSTEM

(71) Applicant: Carl Zeiss Meditec AG, Jena (DE)

(72) Inventors: Stefan Ernsperger, Oberkochen (DE); Dominik Litsch, Oberkochen (DE); Andreas Raab, Oberkochen (DE); Jonathan Essig, Oberkochen (DE); Natalie Krieg, Oberkochen (DE); Andrè Müller, Oberkochen (DE)

(21) Appl. No.: 18/387,836

(22) Filed: Nov. 7, 2023

Related U.S. Application Data
(63) Continuation of application No. PCT/EP2022/062306, filed on May 6, 2022.

(30) Foreign Application Priority Data
May 7, 2021 (EP) 21 172 758.1
May 7, 2021 (EP) 21 172 759.9
Dec. 21, 2021 (EP) 21 216 369.5

(51) Int. Cl. G02B 21/06; G02B 21/00

(52) U.S. Cl. CPC G02B 21/06; G02B 21/0012

(57) ABSTRACT

A microscopy system and a method for operating a microscopy system are provided. The microscopy system includes a tracking camera configured to detect a pose of an object, a tracking illumination device, and a controller configured to control the tracking illumination device and/or the tracking camera. Illumination information is determinable by evaluating an image representation from the tracking camera and/or pose information of the object is determinable relative to at least one illumination device and/or a working distance is determinable, with the illumination by the tracking illumination device and/or an image capture by the at least one tracking camera being able to be set based on the illumination information and/or based on the pose information of the object and/or based on the working distance.

### CROSS REFERENCE TO RELATED APPLICATIONS

This application is a continuation application of international patent application PCT/EP2022/062306, filed May 6, 2022, designating the United States, and claiming priority to European Patent applications EP 21 172 758.1, filed May 7, 2021, EP 21 172 759.9, filed May 7, 2021, and EP 21 216 369.5, filed Dec. 21, 2021, and the entire content of these applications is incorporated herein by reference.

### TECHNICAL FIELD

The disclosure relates to a microscopy system and to a method for operating a microscopy system.

### BACKGROUND

The prior art describes microscopy systems for providing a magnified view of examination objects, in particular in medical applications. Such microscopy systems may be what are known as surgical microscopes. They serve, among other things, to provide a magnified view of regions of a body, in order to give a surgeon a better visual orientation during an intervention. Surgical microscopes are generally mounted in a movable manner, in particular on a stand. Among other things, this allows a user to change a pose, which is to say a position and/or orientation, of the microscope, for example in order to modify a viewing angle onto an examination region or in order to view other examination regions.

DE 10 2018 206 406 B3 describes a microscopy system having a pose detection device for detecting a spatial pose of a target, wherein the pose detection device comprises the at least one target having at least one marker element and an image capture device for optical detection of the target. Furthermore, the document states that the microscopy system may comprise an illumination device for illuminating the target. The described pose detection device may be used in particular to detect the pose of an instrument, for example a medical instrument, when the target is attached to the instrument. Such pose detection may be desirable if for example a current pose of the instrument relative to preoperatively generated data, for example Magnetic Resonance Imaging (MM) or Computed Tomography (CT) volume data, is intended to be displayed.

U.S. Pat. No. 9,827,054 B2 is also known. This document describes the mechanically assisted positioning of medical instruments during medical applications. A microscope and pose detection are also described.

The subsequent publication EP 21 172 758.1 is also known; it describes a microscopy system having a device for determining a working distance, wherein the pose of a movable optical element, the pose of which can be set in order to set a capture region of a tracking camera, can be set based on the working distance. Further, the document describes that a mode of operation and/or an illumination region of tracking illumination devices in the microscopy system can be set based on the working distance.

Also known are microscope-external pose detection devices, which are arranged for example as separate systems in an operating theater. Mention is made, by way of example, of the optical pose detection device from NDI (Northern Digital Inc.) known as Polaris Vega VT. Such detection devices require extra space in the operating theater. Another problem with such pose detection devices are drapes, for example when a user moves between a target and the image capture devices of such a pose detection device. This restricts a range of movement of medical staff. The pose detection using such a pose detection device likewise regularly requires a target having at least one marker also to be arranged on the surgical microscope to provide desired functionalities. The attachment of additional targets to the surgical microscope generally also requires such targets to be disassembled during maintenance, these then being reassembled after maintenance and necessitating recalibration of the pose detection device. Furthermore, such microscope-external pose detection devices require strong illumination, namely to illuminate regions in the operating theater so that all of the targets of interest, which are arranged for example on the patient, on an instrument and on the microscopy system, are able to be imaged reliably. Such systems likewise require high-resolution image capture devices and high computing powers to evaluate the images necessary for the pose detection. Another disadvantage with such pose detection devices is increasing inaccuracy at large distances between a target and the image capture devices.

US2016/373626 A1 is also known; it describes techniques and apparatuses enabling a VCM-actuated autofocus without tilt.

### SUMMARY

It is therefore an object of the disclosure to provide a microscopy system and a method for operating this microscopy system, both of which enable reliable and accurate pose detection and provide an improved quality of use.

The object is achieved by a microscopy system and a method for operating a microscopy system as described herein.

The microscopy system includes a microscope. For the purposes of this disclosure, a microscope refers to a device for magnified visual presentation of an examination object. The microscope may be a conventional light microscope, which generates an enlarged image representation by utilizing optical effects with beam guidance and/or beam shaping and/or beam deflection, for example lens elements. However, the microscope may also be a digital microscope, wherein the image to be visualized by the microscope may be produced with an image capture device and may be displayed on an appropriate display device, for example a display unit.

The microscope may in particular include at least one eyepiece. The eyepiece refers to a part of the microscope through which or into which a user looks to view the image representation produced by the microscope. In other words, an eyepiece forms an eye-side optical interface of the microscope. The eyepiece may form part of a tube. Furthermore, the microscope may include at least one objective or an objective system. This objective may produce a real optical image of an examination object. The objective may in this case include optical elements for beam guidance and/or beam shaping and/or beam deflection. The eyepiece may be optically connected to the objective.

Moreover, the microscope may include a microscope body. The microscope body may have or form a beam path for microscopic imaging. The microscope body may in this case include further optical elements for beam guidance and/or beam shaping and/or beam deflection. The objective may be integrated into the microscope body or be attached thereto, in particular releasably. The objective may in this case be arranged in a fixed position relative to the microscope body. Moreover, the microscope body may have or form at least one attachment interface for attaching, in particular releasably attaching, a tube. The microscope body may include or form a housing or be arranged in a housing.

Furthermore, the microscopy system may include a stand for holding the microscope. The microscope, in particular the microscope body, may consequently be mechanically fastened to the stand. The stand is configured such that it allows a movement of the microscope in space, in particular with at least one degree of freedom, typically with six degrees of freedom, wherein a degree of freedom may be a translational or a rotational degree of freedom. The degrees of freedom in this instance may relate to a reference coordinate system. A vertical axis (z-axis) of this reference coordinate system may be oriented parallel to the gravitational force and counter thereto. A longitudinal axis (x-axis) of the reference coordinate system and a transverse axis (y-axis) of the reference coordinate system may in this instance span a plane oriented perpendicular to the vertical axis. Moreover, the longitudinal axis and the transverse axis may also be oriented orthogonal to one another.

Moreover, the stand may include at least one drive device for moving the microscope. Such a drive device may be a servo motor, for example. Of course, the stand may also include means for transmitting forces/moments, for example gear units. In particular, it is possible for the at least one drive device to be controlled such that the microscope carries out a desired movement and thus a desired change in pose in space or adopts a desired pose, which is to say a position and/or orientation, in space. For example, the at least one drive device may be controlled such that an optical axis of the objective adopts a desired orientation. Moreover, the at least one drive device may be controlled such that a reference point of the microscope, for example a focal point, is positioned at a desired position in space. A target pose in this instance may be specified by a user or by another superordinate system. Methods for controlling the at least one drive device based on a target pose and a kinematic structure of the stand are known here to the person skilled in the art.

The microscopy system includes a tracking camera for detecting the pose of at least one object to be captured. In this case, the tracking camera denotes an image capture device for detecting a spatial pose of at least one object to be captured. The image capture device serves to image the object to be captured. The tracking camera may be part of a pose detection device of the microscopy system. The pose detection device may furthermore include an evaluation or computing device, which may perform pose determination/detection by evaluating the images generated by the tracking camera. In particular, the object to be captured can be a marker or a marker element. The object to be captured may also be an instrument. The instrument can be a medical instrument, more particularly a surgical instrument. For example, this includes instruments such as clamps, holders, syringes, tweezers, spatulas, scissors, scalpels, wound hooks, forceps, aspirators, cauterizing tools, but also retractors, e.g., a brain retractor. The instrument can be an instrument that can be guided by a user's hand. An instrument can also be an item of equipment in an operating theater, for example, an operating table or a Mayfield clamp. It is possible that one or more marker element(s) are arranged on an instrument. The marker or the marker element may in this case be part of a target or be attached to a target. The target or the marker may be attached in particular to a (medical) instrument. Further, the pose detection device, in particular the evaluation device thereof, may identify an object to be captured, in particular based on an image, which is to say by way of image processing and evaluation methods known to a person skilled in the art.

The tracking camera includes an image sensor, such as a charge-coupled device (CCD) or complementary metal-oxide-semiconductor (CMOS) image sensor. For example, a resolution of the image sensor may be 12 megapixels. The tracking camera may furthermore include an optical system having at least one optical element. The pose detection may also serve for pose tracking, which is to say determining the pose at multiple successive points in time. The tracking camera may be used to perform what is known as monoscopic pose detection. In this case, the pose may be determined by evaluating a two-dimensional image representation, in particular exactly one two-dimensional image representation. The tracking camera may be part of a pose detection device that may also include, in addition to the tracking camera, an evaluation device for determining the pose in a predetermined reference coordinate system. The pose refers to a spatial position and/or a spatial orientation in the reference coordinate system. In particular, an evaluation of intensity values of pixels of the two-dimensional image representation may be performed in order to determine the pose. Such methods for image-based pose detection using exactly one tracking camera or multiple tracking cameras are known to a person skilled in the art.

The microscopy system includes at least one tracking illumination device, but typically at least two tracking illumination devices. A tracking illumination device denotes an illumination device for illuminating or fully illuminating a capture region of the at least one tracking camera.

Further, the microscopy system may include at least one optical element, in particular at least one optical element in the form of a lens, for beam-guidance of the radiation generated by the tracking illumination device(s) and at least one control device for controlling the tracking illumination device and/or for controlling the tracking camera.

A computing device or controller may be formed as a microcontroller or an integrated circuit or include such a microcontroller or integrated circuit. In particular, the computing device can be formed by a control device of the microscopy system or be a part thereof. Further, the microscopy system may include a computing device for image evaluation, for pose determination, and for setting the illumination.

The at least one optical element may thus be used to define an illumination region. A tracking illumination device may be configured as a light-emitting diode (LED). A tracking illumination device may in this case generate light in the near-infrared region, typically in a narrowband wavelength range, for example at a wavelength of 850 nm or at a wavelength from a range of 800 nm to 900 nm. In particular, in such an exemplary embodiment, the object to be captured may be formed at least partially or completely from a material that reflects this radiation.

The control device may serve to control a mode of operation, in particular an activation state and/or an intensity of the generated radiation, and/or to set an illumination region of a tracking illumination device. An illumination surface, in particular the size and/or shape thereof, can also be set by the illumination region. One activation state may in this case be “not active”, for example, wherein no radiation is generated by the tracking illumination device in this state. Another activation state may be “active”, wherein radiation is generated by the tracking illumination device in this activation state. The intensity may also be set in the active state. To set an illumination region, an illumination angle, a size and/or a geometric shape of the illumination region may be set, for example by controlling at least one optical element or a plurality of optical elements to set said quantities. It is possible for example that an optical element for beam guidance of the radiation generated by a tracking illumination device is a movable and/or deformable optical element, wherein a pose and/or a shape of this optical element may be changed to set different illumination regions and/or to set different illumination states in different spatial regions. In particular, such an optical element may be an element configured to correspond to a movable optical element for setting the capture region of the tracking camera. The illumination angle may be an emission angle of the illumination device. This may in turn correspond to the aperture angle of a conical illumination region.

Thus, it may therefore be possible that different spatial regions can be illuminated by the tracking illumination devices in region-specific fashion, in particular independently of one another, for example with different illumination parameters such as an intensity and/or an illumination angle. This may be implemented by setting the pose and/or the shape of at least one optical element, but as an alternative or cumulatively also by controlling the mode of operation and/or setting of the illumination region.

According to a first and fourth alternative according to the disclosure, illumination information is determinable or is determined by evaluating at least one image representation from the tracking camera. According to a second and a fifth alternative according to the disclosure or as an alternative or additional feature in the fourth alternative according to the disclosure, pose information of the object relative to at least one illumination device, which is to say information about a pose of the object relative to the illumination device, is determinable or is determined, wherein the pose information in the second alternative according to the disclosure is information about a position and orientation of the object. This determination can be implemented by the control device mentioned above or by an evaluation device that differs therefrom but may likewise be formed as a computing device. According to a third alternative according to the disclosure or as an alternative or additional feature in the fourth alternative according to the disclosure, a working distance is determinable or is determined. This will be explained in more detail below.

Furthermore, according to an aspect of the disclosure, the illumination, in other words an illumination state, can be set or is set by the at least one tracking illumination device and/or the image capture, in other words an image capture state, can be set or is set by the at least one tracking camera on the basis of the illumination information (first and fourth alternative according to the disclosure) and/or the pose information of the object (second and fourth alternative according to the disclosure) and/or on the basis of the working distance (third and fourth alternative according to the disclosure). In this case, the illumination can be set, for example, by way of the mentioned setting of the mode of operation and/or the illumination region of the at least one tracking illumination device, in particular by way of the setting of illumination parameters. The illumination may also be able to be set by setting the pose and/or the shape of a mentioned optical element. The image capture can be set by setting a mode of operation of the at least one tracking camera, in particular via the setting of an image capture parameter such as an exposure time.

The illumination information can be brightness information, which is to say information about a brightness of the image representation or of a partial region of the image representation. For example, the information can be a brightness value. For example, the image brightness can be determined as a mean value of the pixel intensities in the image representation or in the partial region of the image representation. In this case, a pixel intensity can be a grayscale value intensity. In a color image, the image brightness can be determined, for example, as a mean value of pixel intensities which represent the brightness of a pixel in a luma chrominance model, for example in the YCbCr model. To this end, it may be necessary to transform the color image into a representation in accordance with the specified luma chrominance model.

Additionally, the brightness of a pixel may be determined based on the intensity in the color channel assigned to each of the pixels, for example as a mean value of these color channel-specific intensities.

By way of example, if the brightness value is larger than a predetermined threshold value, then the illumination can be modified in such a way that the brightness value is reduced, for example by reducing the overall intensity of the radiation generated by the at least one tracking illumination device. By way of example, if the brightness value is less than a (further) predetermined threshold value, then the illumination can be modified in such a way that the brightness value is increased, for example by increasing the overall intensity of the radiation generated by the at least one tracking illumination device. As an alternative or cumulatively, an exposure time during the image capture can be lengthened, especially if the overall intensity remains constant. If the brightness range in a specific partial region of the image representation is larger than a predetermined threshold value, then the illumination can be modified in such a way that the brightness value is reduced in this partial region but is not modified, or not modified in a different way, outside of the partial region. For example, this can be implemented by reducing the intensity of the radiation, generated by the at least one tracking illumination device, in the spatial region which is imaged into the partial region of the image representation. As an alternative or cumulatively, an exposure time during the image capture can be shortened. If the brightness range in a specific partial region of the image representation is less than a predetermined threshold value, then the illumination can be modified in such a way that the brightness value is increased in this partial region but is not modified, or not modified in a different way, outside of the partial region. For example, this can be implemented by increasing the intensity of the radiation, generated by the at least one tracking illumination device, in the spatial region which is imaged into the partial region of the image representation. Thus the illumination can be set such that the brightness value in the overall image representation, or else in one or more partial regions, is located in a predetermined brightness value interval. To this end, a different illumination can be set in a plurality of spatial regions.

As an alternative or cumulatively, the illumination information can be information about an intensity maximum or about local intensity maxima and/or about an intensity minimum or about local intensity minima in the image representation. Then, the illumination can be set in such a way that the intensity minimum and the intensity maximum or all local intensity minima and all local intensity maxima are located in a predetermined brightness value interval. This makes it possible to reduce the effects of unwanted reflections in the image representation.

In particular, it is possible that the illumination information is determined only for one or more partial regions of the image representation in which an object to be captured is imaged. Such a partial region can be determined by way of methods for identifying objects in image representations, which are known to a person skilled in the art. Then, the illumination can be set in such a way that the brightness value in the partial region or regions determined thus is located in a predetermined brightness value interval, in particular in an interval which enables a reliable image evaluation for determining the pose, for example a reliable and accurate detection of a reference point, for example a center point, of an object to be captured, for example a marker. In other words, it is possible to set an object-specific ideal illumination.

The pose information of the object can be information about the pose of an object relative to at least one illumination device, in particular relative to a tracking illumination device or relative to a field of view illumination device yet to be explained below. Additionally, the illumination device can be a microscope-external illumination device, for example an illumination device installed in the operating theater. The pose of the illumination device may be known in advance or determined by a tracking system. It is possible that the pose information of the object is information about a distance between the object and illumination device, for example a distance value. Then, the illumination can be set in such a way that the overall intensity of the radiation generated by the tracking illumination device or devices is increased with increasing distance from the illumination device and decreased with decreasing distance from the illumination device. As an alternative or cumulatively, the exposure time can be increased with increasing distance and can be reduced with decreasing distance, especially if the overall intensity remains constant.

It is also possible that the intensity in the spatial region in which the object is arranged is increased with increasing distance from the illumination device and reduced with decreasing distance from the illumination device, with the intensity outside of the spatial region not being modified or not being modified in a different way.

If a plurality of objects is situated in different object poses in the illumination region of the tracking illumination device or devices and/or in the capture region of the tracking camera, then the illumination can be set in such a way that there is an object pose-specific illumination for each object. In this case, the setting can be implemented in such a way that a plurality of objects or each of the objects are illuminated at the same time in object pose-specific fashion. For example, if a plurality of objects is at different distances from the illumination device, then it is possible to simultaneously illuminate each of the objects with a distance-specific intensity. In this case, as yet to be explained below, spatial regions which are imaged into different partial regions of the image representation can be illuminated differently, in particular with different intensities.

However, it is also possible that various objects from a set of a plurality of objects are illuminated sequentially in object pose-specific fashion. For example, if a plurality of objects is at different distances from the illumination device, then it is possible to sequentially illuminate each of the objects with a distance-specific intensity. By way of example, it is then possible to generate a first image representation under a first illumination which is adapted to objects in a first distance range, wherein a further image representation is subsequently generated under a further illumination which is adapted to objects in a further distance range, with the distance ranges differing from one another. If distance values in the first distance range are smaller than the distance values in the further distance range, then the intensity of the radiation during the first illumination can be less than the intensity of the radiation during the first illumination. Consequently, there can thus be brighter illumination for a far-field image than the illumination for a near-field image.

It is further possible that various objects from a set of a plurality of objects are captured sequentially in object pose-specific fashion. For example, if a plurality of objects is at different distances from the illumination device, then it is possible to sequentially generate image representations with a distance-specific exposure time. In other words, it is for example possible to generate a first image representation with a first exposure time which is adapted to objects in a first distance range, wherein a further image representation is subsequently generated with a further exposure time which is adapted to objects in a further distance range, with the distance ranges differing from one another. If distance values in the first distance range are smaller than the distance values in the further distance range, then the exposure time for generating the first image representation can be shorter than the exposure time for generating the further image representation. In this case, the illumination intensity for generating the image representations is typically constant.

It is also possible that an illumination region with a spatial intensity distribution known in advance, for example determined by calibration, is assigned to the illumination device. Then, the pose information of the object can be information about a pose in the illumination region. Further, the illumination can be set in such a way that a resultant intensity that based on the object pose-specific intensity, which is generated by the illumination device and determined based on the intensity distribution known in advance, and the intensity generated by the tracking illumination device or devices, the resultant intensity for example as a sum, is in a predetermined intensity interval, for example in an intensity interval which corresponds to a predetermined brightness interval during the imaging. In other words, setting the illumination can bring about a desired illumination of an object with consideration being given to a spatial intensity distribution, known in advance, of an illumination device.

The image capture, in particular an image capture parameter, can be set in illumination-specific fashion. For example, the illumination can be set before the image capture is set, with the illumination scenario-specific image capture then being set based on a previously known assignment of an image capture scenario, for example an exposure time, to various illumination scenarios. However, the illumination may also be set in image capture-specific fashion, with the image capture scenario-specific illumination for example being set based on a previously known assignment of an illumination scenario, for example a to various image capture scenarios. However, it is naturally also possible for the image capture and illumination to be set independently of one another. Setting the illumination based on the illumination information and/or the pose information can be implemented in the form of open-loop or closed-loop control. As a result of this open-loop/closed-loop control, the image representation generated by the tracking camera can be included in the illumination setting.

In particular, it is possible to implement dynamic setting of the illumination, which is to say setting at runtime. Consequently, the illumination can change if there is a change in the illumination information and/or the pose information of the object.

The proposed microscopy system advantageously enables an accurate and reliable pose detection of an object to be captured, the pose of which is intended to be determined, by the tracking camera. Thus, the illumination can be adapted such that there can be a reliable and accurate detection of the object in the image representation and a reliable and accurate evaluation of the image information for the purpose of determining the pose. What advantageously emerges is that an illumination outside of a target region and overexposures and/or underexposures in the target region can be avoided. This can save energy costs and avoid an unwanted development of heat. Also, the generation of stray light by the illumination is reduced.

Further, the microscopy system may include at least one field of view illumination device. In this case, the field of view illumination device can be arranged in or on the microscope body. Additionally, the field of view illumination device differs from the tracking illumination device or devices. An illumination region of the field of view illumination device can be larger than the largest illumination region that can be set for the tracking illumination device or devices. Further, the field of view illumination device can generate radiation at wavelengths from a wavelength range that differs from the wavelengths from the wavelength range of the radiation of the tracking illumination devices. In particular, the wavelength ranges may not intersect or only intersect in a partial region.

As a result, this results advantageously in the illumination for detecting the pose being able to be set independently of the illumination for microscopic imaging, thereby improving an operating quality for a user of the microscopy system.

To determine the working distance to set the illumination and/or the image capture according to the disclosure, as explained above, the microscopy system may include at least one device for determining a working distance.

This working distance of the microscope may denote a distance between a plane of focus and a terminating element of an objective system of the microscope along an optical axis of the microscope, which may be defined by the objective or objective system of the microscope. The terminating element may be for example a lens (front lens) of the objective/objective system or a transparent terminating plate. The plane of focus or detection plane may denote a plane in the object space, wherein an object in this plane is imaged with a desired sharpness. Said plane may be oriented orthogonal to the optical axis of the microscope that intersects the plane of focus at the center of the depth-of-field range. The depth-of-field range is dependent in a known manner on a currently set focal length, the currently set distance, and also the currently set aperture. It is thus possible to determine the plane of focus and hence also the working distance on the basis of at least one of said variables. Of course, other methods for determining the working distance are also conceivable. For example, it is possible that a working distance of the microscope may be set to one or more, but not all, values of a predetermined value range, for example to the value 100 mm, the value 200 mm, and the value 630 mm.

The working distance of the microscope may be determined automatically using methods known to a person skilled in the art. Thus, the working distance may be determined when a pose a plane of focus of the microscope has been set by a user or by performing an autofocus function, in other words, i.e., a focused state of the microscope is set. The focusing is carried out by setting parameters of the objective of the microscope, for example a pose of at least one movable optical element of this objective.

The autofocus function may be performed for example by a focusing device of the microscopy system. In this state, a working distance may then be determined based on the set parameters of the objective, for example via a predetermined assignment, a predetermined characteristic curve or a predetermined function, in particular a polynomial function. For example, an image distance of an objective of the microscope may be set during focusing, wherein a working distance may be assigned to this image distance or a working distance may be determined from a set image distance. For example, it may thus be assumed that a distance of an object, in particular of a marker arranged on an instrument, from the tracking camera of the microscopy system corresponds exactly or approximately to the working distance of the microscope, in particular because a surgeon also uses/moves for example an instrument, in particular with such a marker, generally in the region that is sharply imaged by the microscope.

It is also possible that the microscopy system includes a device for determining a working distance of the tracking camera, wherein this working distance is typically, but not absolutely necessarily, determined on the basis of the working distance of the microscope, for example via a previously known assignment. The assignment allows the working distance of the tracking camera to be assigned to a working distance or a working distance range of the microscope. The working distance of the tracking camera may denote a distance between a plane of focus and a terminating element, for example a (front) lens of an objective system of the tracking camera along an optical axis of the tracking camera, which may be defined by the objective or objective system of the tracking camera. However, it is also conceivable to determine the working distance of the tracking camera independently of the working distance of the microscope. It is also possible for the microscopy system to include a computing device for determining the working distance. In particular, the computing device can be formed by a control device of the microscopy system or be a part thereof.

Hence, a mode of operation of the tracking illumination device or devices and/or an image capture by the at least one tracking camera may also be able to be set based on the working distance. It is possible for different modes of operation of the tracking illumination device or devices and/or different modes of operation of the tracking camera to be assigned to different working distances or ranges, wherein the mode of operation of the tracking illumination devices and/or of the tracking camera is then set by the control device that is assigned to the currently determined working distance or range. Different modes of operation of the tracking illumination device may in this case differ in terms of a plurality of activated tracking illumination devices and/or in terms of the intensity of the radiation generated by at least one activated tracking illumination device. As a further alternative or cumulatively, the illumination region may also be able to be set based on the working distance, in particular by setting the mode of operation of the tracking illumination devices, but also by controlling other elements for the purpose of influencing the illumination region. Various modes of operation of the tracking camera may for example differ in terms of exposure times that differ from one another.

Consequently, a plurality of activated tracking illumination devices and/or an intensity of the activated tracking illumination devices and/or a mode of operation of the tracking camera may thus be able to be set based on the working distance. This makes it possible to be able to set an overall intensity of the radiation generated by the tracking illumination device or devices. The setting may in this case—as explained above—take place in assignment-based fashion, wherein different numbers of activated tracking illumination devices and/or different intensities of the activated tracking illumination device or devices are assigned to the different working distances and are set when a corresponding working distance has been determined at this time. This advantageously results in the illumination being adapted to the working distance, whereby in particular overexposures at short working distances and underexposures at comparatively long working distances can be avoided.

Further, a first overall intensity of the radiation generated by the tracking illumination device or devices can be set for a first working distance. Further, a further overall intensity of the radiation generated by the tracking illumination device or devices is set for a further working distance, wherein the first working distance is shorter than the further working distance and the first overall intensity is lower than the further overall intensity. As explained, it is possible to set the overall intensity by setting the number of activated illumination devices and/or by setting the intensity of the activated illumination devices. However, it may be the case that an activation state of the tracking illumination device can be set, but not the intensity of the radiation generated in the activated state. This advantageously has the result that, for shorter target working distances, lower intensities of the generated radiation may be set for comparatively longer working distances, whereby the risk of overexposure at short working distances and of underexposures at comparatively longer working distances are minimized, which ensures reliable and therefore also accurate pose detection.

For example, an initial illumination and/or an initial image capture, which is to say an illumination with initial illumination parameters and/or an image capture with initial image capture parameters, may be set based on the working distance. This initial illumination and/or initial image capture can be determined and set independently of the illumination information and/or the pose information of the object and can then—as explained above—be modified based on the illumination information and/or pose information of the object. In other words, there can be a working distance-dependent feedforward control of the illumination and/or image capture. Advantageously, this enables a temporally fast and reliable illumination and/or image capture. However, the working distance and the illumination information and/or the pose information of the object may also be considered simultaneously for the purpose of setting the illumination and/or image capture, with the working distance-dependent feedforward control not being carried out.

Setting the illumination and/or the image capture based on the working distance advantageously leads to an accurate and reliable detection of the pose of an object by the tracking camera, and a good operating quality is ensured at the same time.

In a further exemplary embodiment, an overexposure and/or an underexposure of the image representation or of a partial region of the image representation is detectable by evaluating the at least one image representation, with the illumination and/or the image capture being able to be set such that the overexposure or the underexposure is reduced. An overexposure can be detected when a brightness value in the image representation or partial region is larger than a predetermined threshold value. An overexposure of a partial region can also be detected if a ratio of the brightness value in the partial region to a brightness value of the remaining partial region or the overall image representation is larger than a predetermined threshold value. An underexposure can be detected when a brightness value in the image representation or partial region is less than a predetermined threshold value. An underexposure of a partial region can also be detected if a ratio of the brightness value in the partial region to a brightness value of the remaining partial region or the overall image representation is less than a predetermined threshold value. However, other methods for detecting an overexposure or underexposure in the image representation or partial region are naturally also conceivable, for example histogram-based methods. Such methods are known to a person skilled in the art. As already explained above, the detection of the overexposure or underexposure can also be implemented only in partial regions of the image representation in which objects to be captured are imaged. Then, the illumination and/or the image capture can be set in such a way that the overexposure or the underexposure is reduced in these partial regions. In this case, an overexposure or underexposure in further partial regions may not be reduced or only reduced to a different extent. Advantageously, this allows an illumination or image capture to be set, in the case of which the probability of the presence of overexposed and/or underexposed regions is reduced, which in turn allows the generation of image representations whose evaluation enables a reliable and accurate pose determination.

In a further exemplary embodiment, evaluation of the at least one image representation renders identifiable at least one partial region in which the object to be captured or an object to be captured is imaged, with the illumination and/or the image capture being able to be set such that the object is imaged with a predetermined brightness. This has already been explained above. This advantageously results in a simplified setting of the illumination or image capture since there are no brightness rules for image regions outside of the image regions in which an object is imaged.

In a further exemplary embodiment and in the fifth alternative according to the disclosure, the pose information of the object is information about the pose of the object to be captured or of an object to be captured, relative to at least one field of view illumination device with an intensity distribution in its illumination region that is known in advance, with the illumination and/or the image capture additionally being able to be set on the basis of a pose-specific intensity generated by the field of view illumination device. The field of view illumination device may have an inhomogeneous intensity distribution in the illumination region. This has already been explained above. This advantageously results in a temporally faster and simplified setting of the illumination or image capture since information already previously known about the illumination is given consideration by the field of view illumination device during the setting.

In a further exemplary embodiment, spatial regions which are imaged into different partial regions of the image representation are illuminated differently, in particular with different illumination parameters. This has already been explained above. This advantageously allows the setting of an illumination which enables the generation of image representations whose evaluation enables a reliable and accurate determination of the pose, the latter resulting from the targeted illumination.

In a further exemplary embodiment, different spatial regions in which different objects to be captured are arranged and which are imaged into different partial regions of the image representation are illuminated such that each object is imaged with a predetermined brightness. This has already been explained above. This advantageously results in a simplified setting of the illumination or image capture since no illumination rules or rules for the image capture apply to spatial regions in which no object to be captured is arranged.

In a further exemplary embodiment, spatial regions which are imaged into different partial regions of the image representation are illuminated to such a different extent that the difference between the resultant intensity generated in a first spatial region and the resultant intensity generated in a further spatial region is reduced in comparison with a difference between the intensity generated in the first spatial region by the field of view illumination device and the intensity generated in the further spatial region by the field of view illumination device, wherein the resultant intensity, as explained above, is determined based on the intensity, which is generated by the field of view illumination device (and for example can be determined on the basis of the intensity distribution known in advance), and the intensity generated by the tracking illumination device or devices, the resultant intensity for example being determined as a sum. In other words, the illumination can thus bring about a compensation of the inhomogeneous illumination.

In a further exemplary embodiment, the microscopy system includes at least one movable optical element, the pose of which is changeable so as to set a capture region of the tracking camera, with the pose of the movable optical element being able to be set based on the working distance. In this exemplary embodiment, the microscopy system may include in particular the above-described device for determining the working distance. The movable optical element may be part of the objective system of the tracking camera. A viewing angle of the tracking camera may be changed by way of the change in pose. The capture region may in this case be conical, for example. The pose of a focal point of the optical element or of an objective system including the optical element may also be changed by moving the optical element. Further, the microscopy system includes at least one control device for controlling the movable optical element for motion control. This control device makes it possible to control a movement of the movable optical element into a desired pose. This control device can be the control device for controlling the tracking illumination devices, or may differ therefrom.

Further, the pose of the movable optical element can be set based on the working distance. For example, different poses of the movable optical element may each be assigned to different working distances or different working distance ranges, wherein, for a working distance, the pose that is assigned to this working distance, or the region in which the working distance is located, is set. For example, the assignment of a working distance to a pose may be determined using a calibration method. It is also conceivable for there to be a functional relationship between the pose and the working distance, wherein the pose may then be established by evaluating the relationship. The different poses of the movable optical element that can be set define different capture regions, in particular capture regions with differing capture angles. Thus, these poses also define different planes of focus of the tracking camera.

In a further exemplary embodiment, a second capture region of the tracking camera and/or a second illumination state and/or a second image capture state is set, in particular starting from a first capture region, a first illumination state and a first image capture state, respectively, if the working distance increases and reaches a first predetermined threshold value.

Further, a first capture region and/or a first illumination state and/or a first image capture state is set, starting from the second capture region, the second illumination state and the second image capture state, respectively, if the working distance reduces and reaches a second predetermined threshold value which is smaller than the first threshold value. The second capture region can be set by virtue of the movable optical element being moved into a second pose, especially starting from a first pose. The first capture region can be set by virtue of the movable optical element being moved into the first pose, especially starting from the second pose. In this case, the poses of the optical element differ from one another and can also be referred to as positions. The first capture region may have a first capture angle which is larger than the second capture angle of the second capture region. In other words, a first capture region and/or a first illumination state and/or a first image capture state is set if the working distance reduces and reaches a second predetermined threshold value. A second capture region, in particular a second capture angle, and/or a second illumination state and/or image capture state is set if the working distance increases and reaches a first predetermined threshold value. Consequently, setting based on the working distance is affected by hysteresis. This advantageously enables an improved operating quality for a user of the microscopy system, especially since there is a reduced risk of a frequent change of the capture region, the illumination state and/or the image capture state in the case of changes in the working distance about a working point, which may be perceived as irritating by the user. Additionally, setting the illumination and/or the image capture based on the working distance, which is affected by hysteresis, advantageously allows an accurate and reliable detection of the pose of an object by the tracking camera since this avoids a frequent switchover, which has a negative effect on the reliability and accuracy, in the case of a working distance fluctuating about a threshold value.

Setting an illumination state may refer to the setting of at least one illumination parameter. Accordingly, the setting of an image capture state may refer to the setting of at least one image capture parameter.

Typically, the threshold values are chosen in such a way that the capture regions set until the threshold values are reached enable imaging with a sufficiently high resolution. The described aspect may represent an independent disclosure. Consequently, a microscopy system is described, including at least one tracking camera for detecting the pose of at least one object to be captured and at least one device for determining a working distance, further including at least one tracking illumination device and at least one optical element for beam-guidance of the radiation generated by the tracking illumination devices and/or at least one movable optical element, the pose of which is changeable for the purpose of setting a capture region of the tracking camera, wherein a second capture region and/or a second illumination state and/or a second image capture state is set if the working distance increases and reaches a first predetermined threshold value and wherein the movable optical element moves from the second pose into the first pose and/or a first illumination state and/or a first image capture state is set if the working distance reduces and reaches a second predetermined threshold value, which is less than the first threshold value. This microscopy system can additionally be developed here in accordance with one or more of the aspects mentioned in this disclosure.

In a further exemplary embodiment, exactly two poses of the movable optical element can be set repeatably, which is to say with a predetermined repetition accuracy. The repetition accuracy represents the size of a maximum pose deviation which sets in for the multiple movement of the optical element into a specific pose. This repetition accuracy can be determined for example as a standard deviation of the pose deviations for a multiplicity of, for example for more than 100, repeated positioning operations into the pose. Typically, the repetition accuracy is less than or equal to 1 μm or 1°. In other words, a microscopy system configured thus can therefore repeatably set two capture regions. This advantageously yields a mechanically simple configuration of the microscopy system, with however a reliable and accurate pose capture being enabled at the same time.

In a further exemplary embodiment, the movable optical element is movably mounted, typically linearly movably mounted, between two end stop elements, with a first end stop element having or forming a first bearing element for static support and a further end stop element having or forming a further bearing element for static support, with the bearing elements repeatably defining the stop poses of the optical element. Further, the repetition accuracy of a movement pose of the optical element can be less than the repetition accuracy in a stop pose. The movement pose can be a pose between the two stop poses.

The repetition accuracy of a movement pose can represent the extent of a maximum deviation between the actual movement poses that occur for the multiple movement of the carrier into a predetermined movement pose, wherein the carrier is mounted during these movements by a movement bearing element, which is to say the movement bearing element guides the movement of the carrier. The movement pose thus denotes a position and/or orientation of the carrier between the stop poses which can be set by a movement of the carrier that is mounted or guided by the movement bearing element. In other words, the movement bearing element is configured such that, when moving the carrier multiple times into a movement pose, only a repetition accuracy that is lower than the repetition accuracy when moving the carrier multiple times into the stop pose is achievable. The carrier can be moved out of a movement pose into a first stop pose and into a further stop pose, which is to say such a movement is permitted. The carrier can be moved out of the first or further stop pose into a movement pose or into the remaining stop pose. The accuracy being lower may mean that the value of the repetition accuracy is larger than the value of the repetition accuracy in a stop pose, for example ten times larger. In other words, a movement pose of the optical element is not defined repeatably by the movement bearing element in the same way as a stop pose is by the first and the further bearing element. This results advantageously in a simple and cost-effective design of the optical system, since there is no need for highly precise manufacturing of the movement bearing element and optionally of the guiding elements provided by said element.

In a further exemplary embodiment, a first capture angle of the tracking camera is set for a first working distance and a further capture angle of the tracking camera is set for at least one further working distance, wherein the first working distance is less than the further working distance and the first capture angle is larger than the further capture angle. In this context, the capture angle may denote a viewing angle of the tracking camera, in particular a horizontal viewing angle, vertical viewing angle or diagonal viewing angle. The dimension of an intersection of the capture region with a plane that intersects the optical axis of the tracking camera at the first working distance, for example intersects it orthogonally, may thus be larger for the first detection angle than for the further detection angle. This however in turn ensures that objects that are spaced from the terminating element of the tracking camera by the further working distance are also able to be captured with a sufficiently high resolution.

According to the fourth alternative according to the disclosure, the microscopy system includes multiple groups of tracking illumination devices, wherein a group includes at least one, but typically more than one tracking illumination device. By way of example, a group may include what is known as an array of tracking illumination devices. The microscopy system furthermore includes at least two optical elements for beam guidance that are assigned to different groups. This may mean that the radiation generated by the one or more tracking illumination devices of this group is guided by the optical element assigned to the group. By way of example, a first optical element may be assigned to a first group and a further optical element may be assigned to another group of tracking illumination devices. In this case, at least one tracking illumination device of one group may not be part of another group. Typically, none of the tracking illumination devices of one group is part of another group of tracking illumination devices. It is possible for an optical element to be assigned to multiple groups of tracking illumination devices. In this case, the various optical elements for beam guidance differ in terms of at least one assigned group of tracking illumination devices. It is possible for the various illumination devices of a group to be arranged in a row along a common straight line or in a matrix-like manner. In this case, each of the illumination devices of a group may be controlled individually, for example to set an activation state and/or an intensity of the generated radiation. Furthermore, it is possible for the illumination devices to be arranged on a thermally conductive carrier, which is thermally connected to a cooling device for improved heat dissipation. This advantageously has the result that an illumination region may be set in a simple manner, in particular based on the working distance. The (different) optical properties of the optical elements thus make it possible to define different illumination regions or states, wherein the correspondingly defined illumination region is illuminated, especially with a predetermined intensity, upon activation of the tracking illumination devices of the group assigned to the optical element. Mutually different illumination regions may differ in terms of the position, shape, size, or in terms of another property. Adapting the illumination region, especially to the working distance, may advantageously further reduce the risk of the underexposure or overexposure. In turn, this can improve the quality of the pose detection in an advantageous manner since an underexposure or overexposure may lead to an inaccurate and hence unreliable pose detection or to a pose detection not being able to be carried out.

It is likewise advantageously possible to avoid unnecessary illumination of regions that are not of interest to the pose detection, which on the one hand advantageously reduces an energy requirement for the pose detection and on the other hand advantageously reduces unwanted stray light, which may affect the operation of further systems. In particular, the region-specific illumination, explained above, can thus be enabled in simple and reliable fashion.

Further, at least two of the plurality of optical elements for beam guidance may have mutually different optical properties. The optical properties may be selected such that the optical elements, upon activation of one or more groups, set mutually different illumination regions, in particular in a sectional plane perpendicular to the optical axis of at least one element. This advantageously has the result of enabling an easily achievable adaptation of the illumination region, to the working distance, in particular via built-in, static optical elements, which allows an adaptation without a complicated change of optical properties. Of course, however, it is also possible for the different optical elements to have the same optical properties. Further, the illumination angle of the illumination region defined by the optical properties of a first optical element can be larger than the illumination angle of the illumination region defined by the optical properties of another optical element. If the first optical element is assigned to a first group of tracking illumination devices, then these may be activated when a first working distance is determined, wherein the first working distance is shorter than a further working distance, wherein, when the further working distance is determined, the tracking illumination devices of a further group, to which the further optical element is assigned, are activated. In other words, a larger illumination angle of the illumination region may thus be set for comparatively shorter working distances, thereby on the one hand resulting in an adaptation of the illumination angles to the capture angle, but on the other hand unwanted light scattering may also be reduced. In particular, the illumination angles of the illumination regions, of the working distance-dependent illumination regions, may correspond equally to the capture angles in the capture regions, in particular in the working distance-specific capture regions, or be larger than these at most by a predetermined degree. Further, the optical axes of the optical elements for beam guidance may intersect at a common point. Advantageously, this results in the creation of an illumination region by the activation of a plurality of groups whose radiations effectively superimpose to form resultant radiation. However, it is also possible that optical axes of the illumination devices are oriented or arranged differently from one another and do not intersect at a common point. Further, the tracking illumination devices may be operated in pulsed fashion, with a predetermined duty cycle. This duty cycle may be an illumination parameter. In this case, a tracking illumination device can be activated for a predetermined period of time and deactivated for a predetermined further period of time, with the sum of the periods of time equaling a period duration. Further, the period of time of an activated state (and hence also the mentioned duty cycle) is adapted to an exposure period of the tracking camera. In this case, the exposure time duration can be determined by a superordinate system, for example by a camera control device. This camera control device may likewise be a constituent part of the microscopy system and, for example, be signal-connected to the control device. Also, as explained above, the exposure time period may be determined on the basis of illumination information and/or pose information of the object and/or a working distance. This advantageously results in the above-described stray light generation being further reduced, especially since there is also no illumination in portions of time in which no image is generated for pose detection purposes. This likewise reduces the energy requirement of the microscopy system.

Further, the microscopy system may include or form a beam path for generating the microscopic image representation. This beam path may be the beam path of an objective of the microscope and/or be formed by the microscope body. The microscopic image representation in this case refers to the magnified image representation of an examination region. Further, the microscopy system includes or forms at least one further beam path for generating the tracking image representation, with the beam paths differing from one another. In particular, the beam path can be the beam path of an objective system of the tracking camera and/or be formed by the microscope body. For example, the various beam paths can be separated from one another by wall elements and/or web elements. These elements may be formed by the microscope body.

Additionally, the microscopy system may include optical elements which are arranged in or on the respective beam path and serve to generate the image representations. Optical elements arranged in different beam paths may differ from one another. It is possible that a component with the movable optical element and/or the tracking illumination device or devices, and the optical elements for beam guidance is detachably fastened to the microscope body. In other words, it is thus possible to retrofit a pose detection functionality. The component may also include the control device. In this case, appropriate signal lines and connections should then be established for power supply purposes between the component and the microscopy system. However, it is also possible that the aforementioned component parts of the component or at least some of these are integrated in the microscope body. This results in a space-saving provision of a reliable and accurate pose detection, with, however, a high-quality magnification likewise being ensured since the different beam paths mean that the microscopic imaging or the tracking imaging is not influenced.

A method for operating a microscopy system is also provided. In this case, the microscopy system can be formed in accordance with any of the embodiments described in this disclosure. The method includes:
determining illumination information by evaluating at least one image representation from the tracking camera and/or of pose information of the object relative to at least one illumination device and/or of a working distance, and
setting the illumination by the tracking illumination devices and/or of the image capture by the at least one tracking camera based on the illumination information and/or the pose information of the object and/or based on the working distance.

As mentioned above, the method allows the illumination and/or the image capture to be set such that the by the tracking camera under the set illumination and with the set image capture enable a reliable and accurate determination of the pose of the object. In this case, the method is performable by a microscopy system in accordance with any of the exemplary embodiments described in this disclosure. Consequently, the microscopy system is also configured to perform the method.

In particular, the method may thus include:
determining a working distance, and
setting the illumination by the tracking illumination devices and/or capturing an image by the at least one tracking camera based on the working distance.

This and corresponding advantages have already been explained hereinabove.

In a further exemplary embodiment, but also independently of the method steps mentioned above, the/a method may include:
setting a second capture region of the tracking camera, in particular by moving the movable optical element from a first pose into a second, and/or setting a second illumination state and/or a second image capture state when the working distance increases and reaches a first predetermined threshold value, in particular from a state with a set first capture region, from a set first illumination state, and/or from a first image capture state, and
setting a first capture region of the tracking camera, in particular by moving the movable optical element from the second pose into the first, and/or setting a first illumination state and/or a first image capture state if the working distance reduces and reaches a second predetermined threshold value, which is smaller than the first threshold value, in particular from a state with a set second capture region, from a set second illumination state, and/or from a second image capture state.

This, too, was described above with corresponding advantages.

### BRIEF DESCRIPTION OF THE DRAWINGS

The disclosure will now be described with reference to the drawings wherein:

FIG. 1 shows a schematic view of a microscopy system according to an exemplary embodiment of the disclosure,

FIG. 2 shows a schematic cross section through a part of a microscopy system according to an exemplary embodiment of the disclosure,

FIG. 3 shows a schematic cross section through a part of a microscopy system according to a further exemplary embodiment of the disclosure,

FIG. 4 shows a schematic cross section through a part of a microscopy system according to a further exemplary embodiment of the disclosure,

FIG. 5 shows a schematic flowchart of a method according to a first exemplary embodiment of the disclosure,

FIG. 6 shows a schematic flowchart of a method according to a further exemplary embodiment of the disclosure,

FIG. 7 shows a schematic flowchart of a method according to a further exemplary embodiment of the disclosure,

FIG. 8 shows a schematic illustration of the relationship between working distance and illumination state/image capture state, and

FIG. 9 shows a schematic view of different capture regions.

### DESCRIPTION OF EXEMPLARY EMBODIMENTS

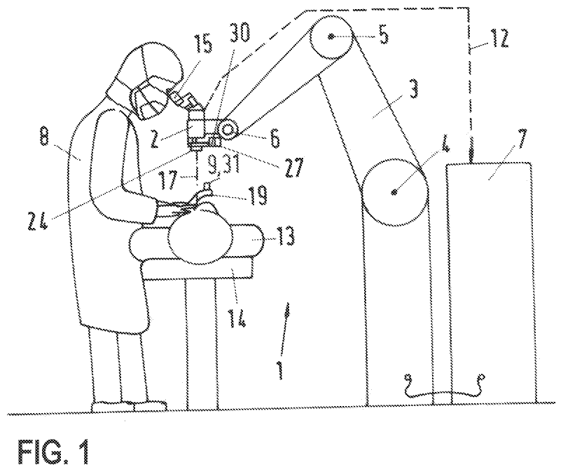

Identical reference signs hereinafter denote elements having identical or similar technical features. FIG. 1 shows a microscopy system 1 according to an exemplary embodiment of the disclosure during use in an operating environment. The microscopy system 1 includes a surgical microscope 2, which is arranged on a stand 3 for mounting the microscope 2, at a free end of the stand 3. The stand 3 allows a movement of the microscope for changing the pose, which is to say the position and/or orientation, of the microscope 2. The stand 3 shown is an exemplary kinematic structure for holding and moving the microscope 2. A person skilled in the art will of course know that other kinematic structures may also be used. Drive devices (not depicted) of the stand 3 may enable a rotational movement of movable parts of the stand 3 about axes of rotation 4, 5, 6. The figure also shows a control device 7 which serves to control the drive devices. Moreover, the control device 7 can also serve to set operating parameters and/or movement parameters of the microscope 2, for example to set a zoom of the microscope 2. To this end, the control device 7 can be signal-connected and/or data-connected to the microscope 2 and/or to the drive devices. Also shown is a patient 13 lying on an operating table 14. Also shown is that the microscope 2 includes an eyepiece 15 into which the user 8 looks to view, through the microscope 2, a partial region of the patient 13, in particular with magnification. Also shown is an optical axis 17 of the microscope 2. The microscopy system 1 moreover includes a pose detection device for detecting a pose of an instrument 19 that can be held and moved by a user 8. The user 8 can be a surgeon, for example. The pose detection device includes at least one target 9 with at least one marker and at least one tracking camera 30 for capturing the target 9. A pose of the target 9 can be determined with the pose detection device. FIG. 1 illustrates that the target 9 is fastened to the instrument 19, with it then also being possible to determine the pose of the instrument 19 on account of the fixed arrangement of the target 9 on the instrument 19. The tracking camera 30 is arranged in a microscope body 24 of the microscope 2, in a housing of the microscope body 24. A capture region EB (see FIG. 7) of the tracking camera 30 in this case at least partially overlaps with a capture region of the microscope 2 for the magnified depiction of the patient or regions of the body of the patient 13. Also shown is a signal-connection and/or data-connection 12 between the tracking camera 30 and the control device 7. With the control device 7 or with an evaluation device (not shown), which may be part of the pose detection device for example, it is possible to determine a relative pose between target 9 and tracking camera 30 in a three-dimensional coordinate system of the pose detection device. By way of example, it is thus possible to determine the pose of the target 9 in a two-dimensional image coordinate system of the tracking camera 30 and then, based on this pose, a pose in the coordinate system of the pose detection device. In this case, both a position and an orientation can be determined in the three-dimensional coordinate system of the pose detection device. This pose can then be converted into the reference coordinate system by way of a known transformation, for example a transformation determined by a registration. The pose of the target 9 can be determined by evaluating exactly one two-dimensional image representation of the tracking camera 30.

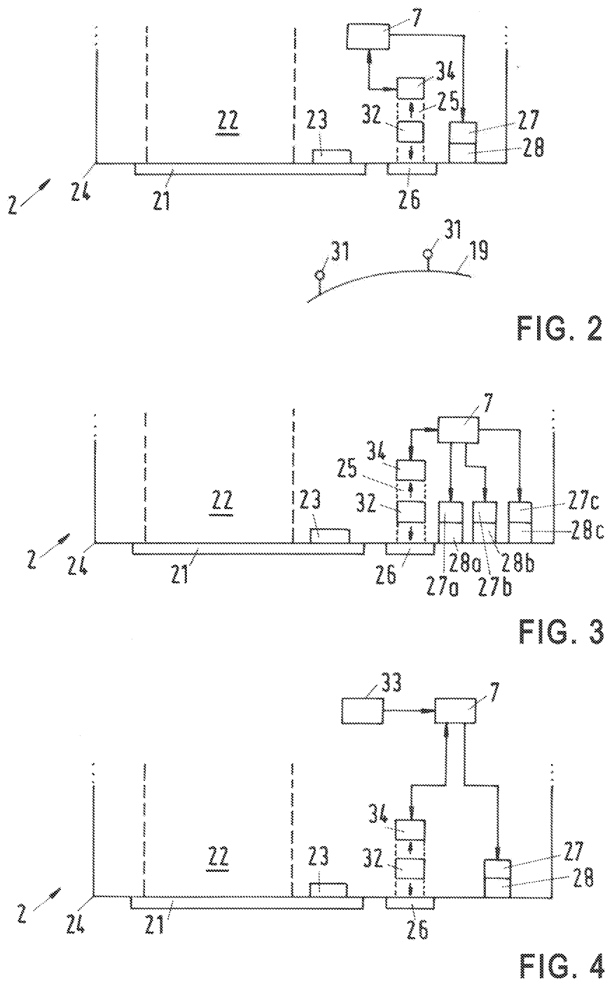

FIG. 2 shows a schematic cross section through a part of a microscopy system according to an exemplary embodiment of the disclosure. A terminating glass 21 of the microscope 2 is shown; it is arranged between a beam path 22 for generating the microscopic image representation and an outside region, for example the room with the patient 13. The terminating glass 21 can be transparent to radiation, at least in the visible wavelength range, but protects the beam path 22 for generating the microscopic image representation from contamination. Also shown is a field of view illumination device 23 which, just like the beam path 22, is integrated in a microscope body 24 of the microscope 2. In this case, the terminating glass 21 covers both the beam path 22 and the field of view illumination device 23. Also shown is a beam path 25 for generating the tracking image representation. This beam path 25 is likewise formed by the microscope body 24 but differs from the beam path 22 for generating the microscopic image representation; in particular, it is separated by wall elements. Also shown is a terminating glass 26 which is arranged between the beam path 25 and the external surroundings. The terminating glass 26 may be transparent to light, at least in the near infrared range, and may differ from the terminating glass 21.

Also shown is a tracking illumination device 27, which is likewise integrated in the microscope body 24 of the microscope 2 and which may be formed as an LED, for example. The tracking illumination device 27 differs from the field of view illumination device 23. The tracking illumination device 27 can generate light in the near infrared range. A lens element 28 is arranged between the tracking illumination device 27 and the external surroundings. The lens element 28 can be a lens element that is changeable in terms of its shape and/or pose, wherein a change in the shape and/or pose may serve to set different illumination states. The shape and/or pose may be able to be set by the control device 7. However, it is not mandatory for the lens element 28 to be changeable in terms of its shape and/or pose.

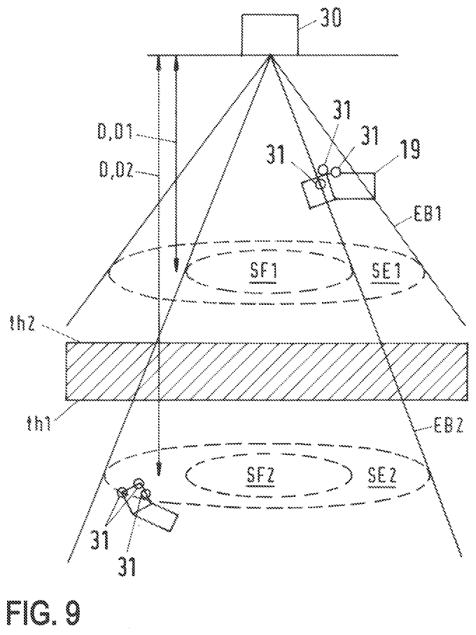

Also shown is a tracking camera 30 (see FIG. 1) which includes an image sensor 34 for generating an image representation, in particular a two-dimensional image representation, a movable optical element 32, and a terminating glass 26. Likewise shown is a control device 7 that serves to control the movable optical element 32, which for example is in the form of a lens. To this end, the control device 7 may be connected via a signal connection to a drive device for generating a drive force which causes the movement (not illustrated). What is shown here is that the optical element 32 can be moved with a translation movement in a beam path 25 for generating the tracking image representation, moved parallel to a mid-axis of the beam path. In this case, it is conceivable that the optical element 32 can be moved between two end stops, with a linear movement. The movement of the movable optical element 32 allows a capture region EB1, EB2 (see FIG. 9, for example) of the tracking camera 30 to be modified, a capture angle EW1, EW2 of the capture region EB. It is also possible that the microscopy system 1 shown in FIG. 2 includes exactly one or more tracking illumination device(s) 27. An operation of the tracking illumination device 27 may be controllable by the control device 7, an activation state and/or an intensity of the radiation generated by the tracking illumination device 27 in the activated state. The control device 7, which is also capable of functioning as an evaluation device, allows the determination of illumination information by evaluating at least one image representation from the tracking camera 30, for example a brightness value in the generated image representation or brightness values in one or more partial regions of the image representation. As an alternative or cumulatively, pose information of the object, which is to say information about the pose of a marker 31 relative to an illumination device, typically relative to the field of view illumination device 23, can be determined with the control device 7. Further, the control device 7 can be used to set the illumination by the tracking illumination devices 27 and/or the image capture by the at least one tracking camera 30 based on the illumination information and/or the pose information of the object. In other words, it is possible to set an illumination state and/or an image capture state, wherein an illumination state can be set, for example, by setting at least one illumination parameter and/or by setting an image capture state by setting at least one image capture parameter, for example the exposure time, and different states may differ in the value of at least one parameter.

FIG. 3 shows a schematic cross section through a part of a microscopy system 2 according to a further exemplary embodiment of the disclosure. In contrast with the exemplary embodiment depicted in FIG. 2, the microscopy system 2 depicted in FIG. 3 includes a plurality of tracking illumination devices 27a, 27b, 27c and a plurality of lens elements 28a, 28b, 28c. The lens elements 28a, 28b, 28c may have differing optical properties, in particular differing focal lengths. In this case, the radiation generated by the tracking illumination device 27a, 27b, 27c radiates through the lens element 28a, 28b, 28c assigned to this tracking illumination device 27a, 27b, 27c. The lens elements 28a, 28b, 28c may be formed by a lens composite element 29, with this lens composite element 29 comprising various portions that form the lens elements 28a, 28b, 28c. To set the illumination, the tracking illumination devices 27a, 27b, 27c may be controlled independently of one another with the control device 7. Additionally, the lens elements 28a, 28b, 28c may be controlled independently of one another for the purpose of setting the illumination, for example if their shape and/or pose is changeable. It is also possible that the microscopy system 1 includes groups of a plurality of tracking illumination devices 27, wherein the tracking illumination devices 27 may be in the form of LEDs or include the latter. A group may include one or more so-called LED array(s), wherein each of the tracking illumination devices 27 of each group can be controlled on an individual basis; different lens elements 28a, 28b, 28c may be assigned to different groups.

FIG. 4 shows a schematic cross section through a part of a microscopy system 2 according to a further exemplary embodiment of the disclosure. In contrast with the exemplary embodiment depicted in FIG. 2, the microscopy system 2 depicted in FIG. 3 includes a device 33 for determining a working distance D (see FIG. 9). The latter is connected to the control device 7 for information transfer purposes. Then, the control device 7 can be used to set the illumination and/or the image capture also based on the working distance D. Further, the pose of the movable optical element 32 can also be set based on the working distance D.

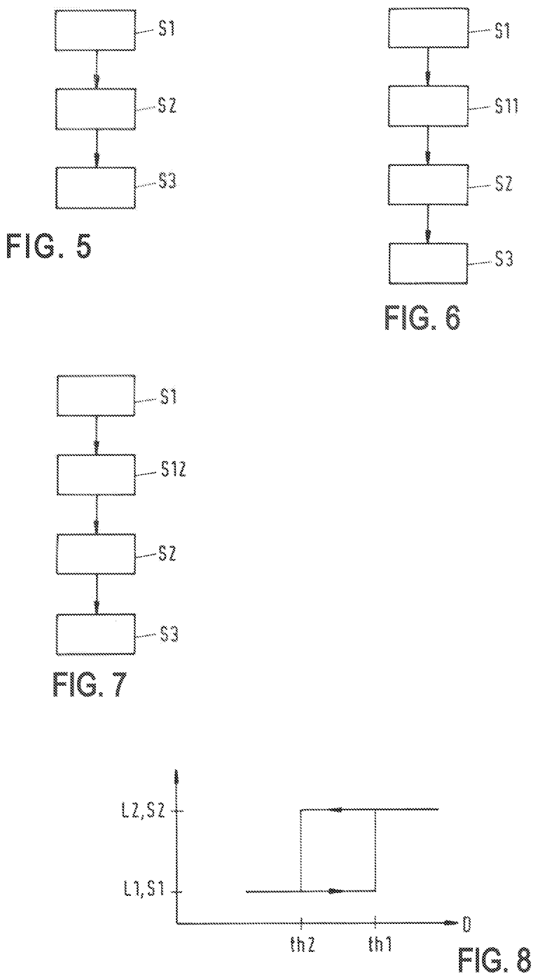

FIG. 5 shows a schematic flowchart of a method according to a first exemplary embodiment of the disclosure. In a first step S1, an image representation is generated by a tracking camera (see FIG. 2, for example). In a second step S2, this image representation is then evaluated, in particular with an evaluation device, for example the control device 7 depicted in FIG. 2, and—as mentioned above—illumination information and/or pose information of the object is determined. In a third step S3, an illumination by the tracking illumination device 27 and/or the image capture by the at least one tracking camera 30 is set based on the illumination information and/or the pose information of the object, for example also with the control device 7. The illumination can be implemented by controlling the tracking illumination device or devices 27 and/or the lens element or elements 28. Exemplary settings of the illumination and/or the image capture based on the illumination information and/or the pose information of the object were explained above.

FIG. 6 shows a schematic flowchart of a method according to a further exemplary embodiment of the disclosure. In contrast with the exemplary embodiment shown in FIG. 5, the method includes a step S11 for determining a working distance D. In the third step S3, the illumination can then additionally be set based on the working distance D by the tracking illumination device 27 and/or the image capture by the at least one tracking camera 30. Further, in the third step S3, the pose of at least one optical element 32 (see FIG. 2) can be set based on the working distance.

FIG. 7 shows a schematic flowchart of a method according to a further exemplary embodiment of the disclosure. In contrast to the exemplary embodiment depicted in FIG. 5, the method includes a step S12 for identifying partial regions in which markers 31 are imaged (see FIG. 2). Then, in the second step S2, this partial region of the image representation is evaluated and—as mentioned above—illumination information for these partial regions is determined. In a third step S3, an illumination by the tracking illumination device 27 and/or the image capture by the at least one tracking camera 30 is set based on the illumination information, for example also with the control device 7, in particular in such a way that the markers 31 are imaged with a predetermined brightness after the setting has been implemented.

FIG. 8 shows a schematic illustration of the relationship between a working distance D and illumination states S1, S2 and capture states, wherein a first pose L1 of an optical element 32 is set in a first capture state for the purpose of setting a capture region EB of the tracking camera 30, and a second pose L2 of the optical element 32 is set in a second capture state. What is shown is that the optical element 32 is moved from the first pose into the second L1, L2 and a second illumination state S1 is set if the working distance D increases and reaches or overshoots a first predetermined threshold value th1. Additionally, the movable optical element 32 is moved from this second pose L2 into the first pose L1 and/or a first illumination state S1 and/or a first image capture state is set from this second illumination state S2 or image capture state if the working distance D reduces and reaches or undershoots a second predetermined threshold value th2 which is smaller than the first threshold value th1.

FIG. 9 shows a schematic view of different capture regions EB1, EB2 which are set for different working distances D1, D2. Also shown is the tracking camera 30, wherein the latter may include a movable optical element 32 whose pose is changeable for the purpose of setting a capture region EB of the tracking camera 30. However, other options for setting various capture regions EB1, EB2 are also conceivable. For example, a first capture region EB1 is set for a first working distance D1 along an optical axis of the microscope between a first plane of focus SE1, in which for example a first target region (area of interest) having a first operating field SF may be arranged, and a terminating element of an objective system of the microscope. This setting allows a reliable capture of an instrument 19 with markers 31, which is situated in the surroundings of the first operating field SF1. For example, a second capture region EB2 with a smaller capture angle than the capture angle of the first capture region EB1 is set for a second, longer working distance D2 between a further plane of focus SE2, in which for example a further target region having a further operating field SF2 may be arranged, and the terminating element. This can ensure a sufficiently high resolution and hence high-quality imaging of markers 31, for example, which are in the surroundings of the further operating field SF2. A hatched box labels a range of working distances D for which the first or the further capture region EB1, EB2 can be set, wherein the setting of the first or further capture region EB1, EB2 to a value from this range in the case of a change in the working distance D is dependent on the initial value of the working distance D before the change.

### LIST OF REFERENCE NUMERALS

1 Microscopy system
2 Microscope
3 Stand
4, 5, 6 Axes of rotation
7 Control device
8 User
9 Target
12 Signal connection
13 Patient
14 Operating table
15 Eyepiece
17 Optical axis
19 Instrument
21 Terminating glass
22 Beam path for microscopic imaging
23 Field of view illumination device
24 Microscope body
25 Beam path for the tracking image representation generation
26 Terminating glass
27, 27a, 27b, 27c Tracking illumination device
28a, 28b, 28c Lens element
29 Lens composite element
30 Tracking camera
31 Marker
32 Movable optical element
33 Device for determining a working distance
34 Image sensor
EB1, EB2 Capture region
D, D1, D2 Working distance
S1, S2, S3, S11, S12 Step
th1, th2 Threshold value
L1, L2 Pose
S1, S2 Illumination state

What is claimed is:

1. A microscopy system, comprising:
at least one tracking camera configured to detect a pose of at least one object to be captured;
at least one tracking illumination device; and
at least one controller configured to control the at least one tracking illumination device or the tracking camera,
wherein illumination information is determined by evaluating at least one image representation from the tracking camera, with the illumination by the tracking illumination device or an image capture by the at least one tracking camera being set based on the illumination information.

2. A microscopy system, comprising:
at least one tracking camera configured to detect a pose of at least one object to be captured;
at least one tracking illumination device; and
at least one controller configured to control the at least one tracking illumination device or the tracking camera,
wherein information about the position and orientation of the object relative to at least one illumination device is determined, with the illumination by the tracking illumination device or an image capture by the at least one tracking camera being set based on the information about the position and orientation of the object relative to the at least one illumination device.

3. A microscopy system, comprising:
at least one tracking camera configured to detect a pose of at least one object to be captured and a microscope with a working distance of the microscope;
at least one tracking illumination device;
at least one controller configured to control the at least one tracking illumination device,
wherein a working distance of the microscope is determined, with the illumination by the tracking illumination device being set based on the working distance of the microscope, with a second illumination state being set if the working distance of the microscope increases and reaches a first predetermined threshold value, with a first illumination state being set if the working distance of the microscope reduces and reaches a second predetermined threshold value which is less than the first threshold value.

4. A microscopy system, comprising:
at least one tracking camera configured to detect a pose of at least one object to be captured;
at least one tracking illumination device;
at least one controller configured to control the at least one tracking illumination device and/or the tracking camera, wherein illumination information is determinable by evaluating at least one image representation from the tracking camera and/or pose information of the object is determinable relative to at least one illumination device and/or a working distance is determinable, with the illumination by the tracking illumination device and/or an image capture by the at least one tracking camera being able to be set based on the illumination information and/or based on the pose information of the object and/or based on the working distance;
a plurality of groups of tracking illumination devices, with one group including at least one tracking illumination device; and
at least two optical elements for beam guidance which are assigned to different groups.

5. A microscopy system, comprising:
at least one tracking camera configured to detect a pose of at least one object to be captured;
at least one tracking illumination device;
at least one controller configured to control the at least one tracking illumination device or the tracking camera,
wherein pose information of the object is determined relative to at least one illumination device, with the illumination by the tracking illumination device or an image capture by the at least one tracking camera being set based on the pose information of the object, with the pose information of the object being information about the pose of the object to be captured relative to at least one field of view illumination device with an intensity distribution in its illumination region that is known in advance, with the illumination and/or the image capture additionally being able to be set based on a pose-specific intensity generated by the field of view illumination device.

6. The microscopy system as claimed in claim 1, wherein an overexposure and/or an underexposure of the image representation or of a partial region of the image representation is detectable by evaluating the at least one image representation, with the illumination and/or the image capture being able to be set such that the overexposure and/or the underexposure is reduced.

7. The microscopy system as claimed in claim 1, wherein evaluation of the at least one image representation renders identifiable at least one partial region in which the object to be captured is imaged, with the illumination and/or the image capture being able to be set such that the object to be captured is imaged with a predetermined brightness.

8. The microscopy system as claimed in claim 2, wherein the pose information of the object is information about the pose of the object to be captured, relative to at least one field of view illumination device with an intensity distribution in its illumination region that is known in advance, and
wherein the illumination and/or the image capture additionally can be set based on a pose-specific intensity generated by the field of view illumination device.

9. The microscopy system as claimed in claim 1, wherein spatial regions imaged into different partial regions of the image representation are illuminated differently and/or different spatial regions in which different objects to be captured are arranged and which are imaged into different partial regions of the image representation are illuminated such that each object is imaged with a predetermined brightness.

10. The microscopy system as claimed in claim 9, wherein spatial regions which are imaged into different partial regions of the image representation are illuminated to such a different extent that the difference between the resultant intensity generated in a first spatial region and the resultant intensity generated in a further spatial region is reduced in comparison with a difference between the intensity generated in the first spatial region by the field of view illumination device and the intensity generated in the further spatial region by the field of view illumination device.

11. The microscopy system as claimed in claim 3, further comprising:
at least one movable optical element, the pose of which is changeable to set a capture region of the tracking camera, wherein the pose of the movable optical element can be set based on the working distance of the microscope.

12. The microscopy system as claimed in claim 11, wherein exactly two poses of the movable optical element can to be set repeatably.

13. The microscopy system as claimed in claim 11, wherein the movable optical element is movably mounted between two end stop elements,
wherein a first end stop element has or forms a first bearing element for static support and a further end stop element has or forms a further bearing element for static support, and
wherein the bearing elements repeatably define the stop poses of the optical element.

14. The microscopy system as claimed in claim 3, further comprising:
at least one controller configured to control the tracking camera,
wherein a second capture region of the tracking camera and/or a second image capture state is set when the working distance of the microscope increases and reaches a first predetermined threshold value, and
wherein a first capture region and/or a first image capture state are set when the working distance of the microscope reduces and reaches a second predetermined threshold value which is less than the first threshold value.

15. The microscopy system as claimed in claim 4, wherein a second capture region of the tracking camera and/or a second illumination state and/or a second image capture state is set when the working distance of the microscope increases and reaches a first predetermined threshold value, and
wherein a first capture region and/or a first illumination state and/or a first image capture state is set when the working distance of the microscope reduces and reaches a second predetermined threshold value which is less than the first threshold value.

16. The microscopy system as claimed in claim 4, wherein a first capture angle of the tracking camera is set for a first working distance of the microscope and a further capture angle of the tracking camera is set for at least one further working distance of the microscope, and
wherein the first working distance of the microscope is less than the further working distance of the microscope and the first capture angle is larger than the further capture angle.

17. The microscopy system as claimed in claim 1, further comprising:
a plurality of groups of tracking illumination devices, wherein one group includes at least one tracking illumination device; and
at least two optical elements for beam guidance which are assigned to different groups.

18. A method for operating a microscopy system as claimed in claim 1, the method comprising:
determining illumination information by evaluating at least one image representation from the tracking camera; and
setting an illumination by the tracking illumination device or an image capture by the at least one tracking camera based on the illumination information.

19. A method for operating a microscopy system as claimed in claim 2, the method comprising:
determining information about the position and orientation of the object relative to at least one illumination device; and
setting an illumination by the tracking illumination device or an image capture by the at least one tracking camera based on the information about the position and orientation of the object relative to the at least one illumination device.

20. A method for operating a microscopy system as claimed in claim 3, the method comprising:
determining a working distance of the microscope;
setting an illumination by the tracking illumination device based on the working distance of the microscope, the setting of the illumination comprising:
setting a second illumination state when the working distance of the microscope increases and reaches a first predetermined threshold value; and
setting a first illumination state when the working distance of the microscope reduces and reaches a second predetermined threshold value which is less than the first threshold value.

21. A method for operating a microscopy system as claimed in claim 4, the method comprising:
determining illumination information by evaluating at least one image representation from the tracking camera and/or of pose information of the object relative to at least one illumination device and/or of a working distance,
setting an illumination by the tracking illumination device and/or of an image capture by the at least one tracking camera based on the illumination information and/or based on the pose information of the object and/or based on the working distance.

22. A method for operating a microscopy system as claimed in claim 5, the method comprising:
determining pose information of the object relative to at least one illumination device; and
setting an illumination by the tracking illumination device or an image capture by the at least one tracking camera based on the pose information of the object.
